(19) United States
(12) Patent Application Publication
(10) Pub. No.: US 2002/0141039 A1
(43) Pub. Date: Oct. 3, 2002

(54) Spatial light modulation

(76) Inventors: Michael Mermelstein, Cambridge, MA (US); Abraham McAllister, Cambridge, MA (US); Cameron Abnet, Waltham, MA (US); Daniel Feldkhun, Brighton, MA (US)

Correspondence Address: CHARLES HIEKEN, Fish & Richardson P.C., 225 Franklin Street, Boston, MA, 02110-2804, US

(21) Appl. No.: 09/825,452

(22) Filed: Apr. 2, 2001

(51) Int. Cl. G02F 1/33; G02F 1/29; G02B 26/08

(52) U.S. Cl. 359/305; 359/298

(57) ABSTRACT

A method for spatially modulating radiation includes directing at least one radiation beam upon at least one surface acoustic wave diffractive element, and driving at least one of the surface acoustic diffractive elements with a plurality of modulating signals to generate a plurality of modulated output radiation beams having parameters.

### CROSS-REFERENCE TO RELATED APPLICATIONS

Not applicable.

### STATEMENT REGARDING FEDERALLY SPONSORED RESEARCH OR DEVELOPMENT

Not applicable.

This invention relates to a method and apparatus for modulating radiation, and more particularly to the use of an array of controlled surface acoustic wave devices for modulating the amplitude, phase, frequency, and/or direction of one or more radiation beams.

### BACKGROUND OF THE INVENTION

Longitudinal and transverse waves propagating through solids have long been used to achieve control over optical and electrical signals. These devices can be divided into two classes, bulk acoustic wave devices and surface acoustic wave devices.

Bulk acoustic waves are waves that travel through the bulk of a material. Because longitudinal bulk acoustic waves can cause a periodic gradient in the index of refraction in a transparent crystal, they are commonly used to modulate an optical beam passing through a crystal in a device called an acousto-optic modulator (AOM). AOMs typically employ a piezoelectric transducer cemented to the crystal to convert RF electronic drive signals into acoustic waves. The resulting index of refraction gradient appears essentially as a Bragg diffraction grating to the incident optical beam, causing it to diffract. The angle of diffraction, as well as the amplitude and phase of the diffracted beams can be controlled precisely by varying the frequency, amplitude, and phase of the electronic drive signal. Furthermore, because acoustic waves are usually traveling through the crystal, a Doppler frequency shift corresponding to the drive frequency is imparted on the diffracted beam of light.

AOMs have been used in numerous beam scanning applications, for electro-optical switching and conversion, for optical signal processing, as well as for tuning the wavelength of a laser cavity. Multi-channel AOMs have been developed to control several light beams independently within a single crystal. A superposition of multiple frequencies has been used to drive a single AOM in order to generate and independently control multiple diffracted beams Surface acoustic waves (SAWs) are a combination of waves that propagate along the surface of elastic solids, creating height deviations in the surface, much like ripples in a still pond. The surface acoustic waves may create a standing or traveling pattern depending on the geometry of the system and the inputs to the system. For purposes of this disclosure, surface acoustic waves are meant to include propagating waves that produce periodic deflections of the surface of a material, such as Lamb waves and flexural waves. Although the name suggests otherwise, surface acoustic waves as described in this application do not necessarily travel at the speed of sound in the material.

SAWs are commonly launched in a piezoelectric material, such as lithium niobate (LiNbO3), by applying radio frequency electric signals to an inter-digital transducer (IDT) lithographically deposited on the surface. The piezoelectric substrate expands and contracts in response to the differences in electric potential between the fingers of an IDT, causing waves to propagate through the surface.

SAW devices are used as narrow-band electronic frequency filters, resonators, and delay lines. The relatively slow propagation velocity, and hence long wavelength, of surface acoustic waves renders high frequency electric signals easily accessible for manipulation by precisely spaced microstructures such as an IDT. Since the operating frequency of the SAW device is closely coupled to the pitch and width of IDT fingers, the bandwidth of SAW devices is usually very narrow.

### SUMMARY OF THE INVENTION

In one aspect, the present invention is a method, system and apparatus comprising spatial light modulator (SLM). An SLM is a one or two dimensional array of closely packed elements used to alter the spatial structure of incident light, or a single element to control multiple beams simultaneously such as through frequency multiplexing. SLM elements can be reflective or transmissive, can be entirely solid state or include moving components, and may be used to modulate the direction, frequency, phase, and/or amplitude of the incident radiation. SLMs may be used to generate patterns for optical signal processing, image display, and pattern writing applications. In another aspect, the present invention may be applied to optical switches, wherein an SLM consisting of a one- or two-dimensional array of closely packed deflecting elements is used to route optical signals in a fiber optic network.

It is an object of the present invention to provide a method and apparatus for generating multiple beams of radiation by diffraction of radiation from a grouping of surface acoustic wave (SAW) modulators, wherein each modulator is independently controllable to modulate the frequency, deflection angle, amplitude, and/or phase of the incident radiation. The first order diffraction efficiency of a reflective SAW modulator is theoretically limited to approximately 30% and is typically only a few percent. Since only a few percent of light inside a laser cavity is typically released, a system with a SAW SLM used as a laser output coupler can achieve much higher light throughput than if the same SLM were used outside the laser cavity—even higher than the theoretical diffraction efficiency limit.

In one aspect, the invention comprises a method which includes (1) providing at least one radiation beam, (2) positioning a plurality of SAW modulators to receive said beam or beams, (3) driving said plurality of SAW modulators with a stimulus to generate many output beams of radiation, and (4) controlling said stimulus to modulate at least one of said output beams

In another aspect, the invention comprises an apparatus which includes (1) a source of radiation (2) an array of SAW optical modulators, and (3) an electronic drive system for controlling said array of SAW modulators.

One embodiment of this invention includes an array of reflective SAW modulator cells comprising a spatial light modulator (SLM), wherein each modulator cell includes an interdigital transducer (IDT) adjacent to a reflective active area on the surface of a piezoelectric substrate. Each modulator cell is independently controlled by an electric stimulus to modulate the incident light.

Another embodiment of this invention includes an array of transmissive SAW modulators, wherein the active areas are transparent and the output beams emerge on the opposite side of the SAW plane from the input beams.

Another embodiment of this invention includes the use of a composite stimulus containing multiple frequencies to drive each SAW modulator cell. This results in diffraction of multiple independently-modulated output beams by each SAW modulator cell.

Another embodiment of this invention includes using a SAW SLM as an output coupler inside a laser cavity in order to reduce the effects of low diffraction efficiency on light throughput.

Another embodiment of this invention includes an array of SAW modulator cells comprising an optical switch, wherein each SAW modulator cell is used to direct a light beam from a corresponding transmitter in the transmitter array to a desired receiver in the receiver array.

Another embodiment of this invention includes a SAW SLM as a part of a system used in lithography for the production of semiconductor devices and microelectro-mechanical systems (MEMS). The SAW SLM in this embodiment controls one or more beams of radiation for exposure of photosensitive material or for ablation of materials.

In yet another embodiment, a SAW SLM is used as part of a system for microscopy, as in, for example, synthetic aperture microscopy systems.

The use of a surface acoustic wave optical modulator as the basic element of a spatial light modulator offers several advantages over other SLM technologies. One advantage is high device reliability due to the solid-state architecture of a SAW device. SAW devices do not rely on moving components, which have the tendency to stick, break, and deteriorate with time. Moreover, SAW devices withstand adverse environmental conditions, including high humidity, temperature, and shock.

Another advantage of the SAW SLM is ease of manufacturing. The SAW modulator array can be made by depositing the IDTs and the reflective active areas on top of the piezoelectric substrate in a single lithography step. Furthermore, process uniformity in SAW device manufacturing is not critical, as deviation in IDT pitch or finger width results in a reduction in diffraction efficiency at the nominal drive frequency at the most. An additional benefit of a single-layer manufacturing process is the quality of the mirror surface, which does not suffer from print-through of underlying layers as is common in DMD devices.

A further advantage of the SAW SLM is speed. The bandwidth of DMD arrays is typically limited to tens of KHz by the frequency response of the micromechanical mirror structures. SAW devices, on the other hand, can be controlled with a bandwidth of many MHz. Furthermore, a single SAW modulator driven with a composite stimulus can be used to control multiple beams, resulting in further improvement in throughput.

A still further advantage of the SAW SLM is control flexibility. By driving a SAW modulator cell with a single stimulus signal, one can simultaneously control the amplitude, phase, direction, and Doppler frequency shift of a light beam or multiple light beams if a compound signal is used. This degree of control is unmatched by SLM technologies used in prior art.

Other features, objects and advantages will become apparent from the following detailed description when read in connection with the accompanying drawings.

### BRIEF DESCRIPTION OF THE SEVERAL VIEWS OF THE DRAWING

FIG. 1 is a schematic diagram of a prior art reflective SAW modulator.

FIG. 2 is a schematic diagram of a transmissive SAW modulator.

FIGS. 3 and 3b are schematic diagrams of a thin film SAW modulators.

FIGS. 4a, 4b, 4c are schematic diagrams of thin film SAW modulator configurations.

FIGS. 5a, 5b, 5c and 5d are schematic diagrams of different arrays of SAW modulators comprising a spatial light modulator.

FIG. 6 is a schematic diagram of a laser cavity with an active SAW SLM output coupler.

FIG. 7 is a schematic diagram of a fiberoptic switch.

FIG. 8 is a block diagram of a SAW SLM used in a lithographic system.

FIG. 8a is a block diagram of a SAW SLM used in a microscopy application.

FIG. 9 shows a block diagram of maskless lithography using a SAW modulator.

FIG. 10 shows a multi-frequency SAW modulator.

FIG. 11 shows a graph depicting a time division multiplexing scheme.

FIG. 12 shows a graph depicting a frequency multiplexing scheme.

FIG. 13 shows a graph of packet multiplexing.

FIGS. 14 and 14b show diagrams of channel multiplexing configurations. .

Like reference symbols in the various drawings indicate like elements.

### DETAILED DESCRIPTION

A spatial light modulator (SLM) comprises light-modulating reflective surface acoustic wave (SAW) devices. When driven with a high frequency electrical stimulus, each inter-digital transducer (IDT) creates a traveling surface wave in the adjacent rectangular active area on the piezoelectric substrate. The traveling ripples in the reflective surface diffract the incident light beam into multiple diffraction orders according to the grating equation:

sin θ_{d}+sin θᵢ=mλ/d

where:

θᵢ is the angle of incidence

θ_{d} is the angle of diffraction

m is the order of the diffracted beam

λ is the wavelength of incident light

d is the pitch of the grating

The acoustic wavelength, and hence the pitch of the grating, is determined by:

d=v/f

where:

v is the velocity of the surface wave

f is the frequency of the drive stimulus

It is desirable that the first order beam be used as the output beam from each SAW modulator, while the other diffraction beams are blocked. In another embodiment, several diffracted beams are combined using additional optics to form a brighter output beam.

The above equations show how the direction of a diffracted beam can be modulated by varying the frequency of the acoustic wave. It can be shown that a change in the phase of the acoustic wave results in an identical change in the phase of the diffracted light beams and that a change in the amplitude of the acoustic wave results in a change in diffraction efficiency of the grating. Thus, by controlling the frequency, phase, and amplitude of the electric stimulus used to generate the SAW, the direction, phase, and amplitude of the output beam can be independently modulated in a continuous manner

In addition to diffracting the incident beam, the traveling SAW grating adds a Doppler frequency shift to the diffracted beams equal to the frequency of the stimulus drive. An embodiment of this invention includes creating standing surface acoustic waves using opposing transducers or acoustic reflectors in order to eliminate the Doppler shift from the diffracted beams.

A reflective SAW SLM is not only useful for modulating visible light, but can be used to modulate any radiation reflected by the active surface, including V, IR and X-ray radiation. Radiation beams may be pulsed or continuous.

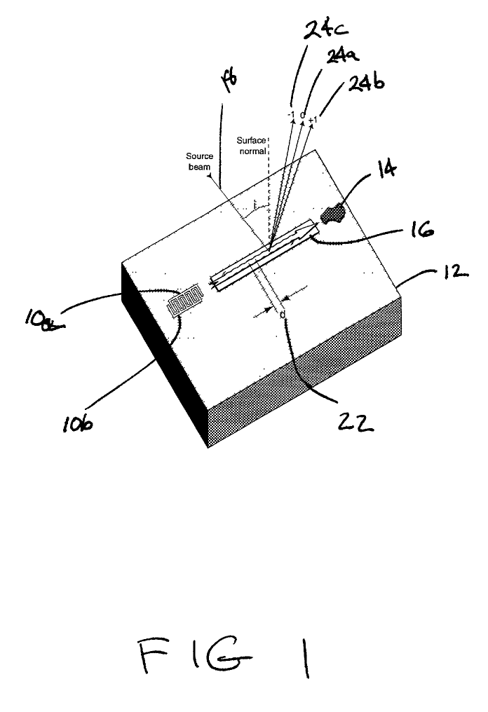

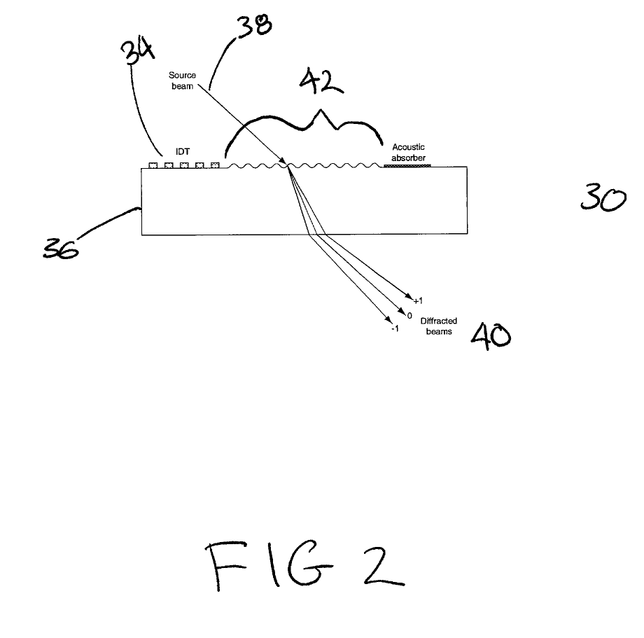

With reference to FIG. 1, interdigital transducers 10a and 10b are shown deposited on a piezoelectric substrate 12. Surface acoustic waves are generated by stimulating the IDT 10a and 10b with an RF electric signal (not shown) and propagate with the speed of sound along the surface of the piezoelectric material 12 before being absorbed by an acoustic absorber 14. An active area 16 is defined by a reflective surface deposited in the path of the acoustic wave. A light beam 18 with wavelength λ incident on the active area 16 at the angle of incidence θᵢ 20 is diffracted by the traveling acoustic grating of period d 22. The output consists of many beams corresponding to many diffraction orders. Only the 0^{th} 24a (reflected), 1^{st} 24b and −1^{st} 24c diffraction orders are shown for simplicity.

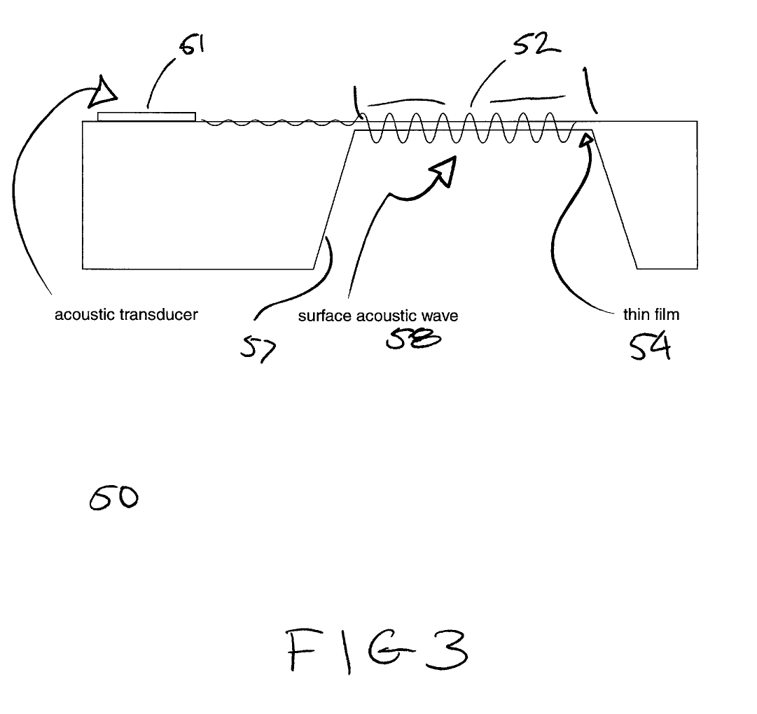

With reference to FIG. 2, a transmissive SAW modulator 30 is shown. As in the reflective SAW modulator, surface waves 32 are generated by an IDT 34 on a piezoelectric substrate 36 and diffract an incident beam 38 of light into many diffraction orders 40. However, the active area 42 is transparent in this case, so that the diffracted beams 40 pass through the piezoelectric substrate 36 and emerge on the other side. In a transmissive SAW modulator as shown, the incident light 38 is incident on the grating out of the plane of propagation of the acoustic wave. The diffractive behavior of the transmissive SAW modulator is very similar to the reflective SAW modulator, with the additional effects of refraction caused by the piezoelectric substrate. Although the spectral response of the transmissive SAW modulator is limited by the transmission characteristics of the substrate, such a modulator may be advantageous in applications where near-field spatial modulation is desired at nearly normal incidence.

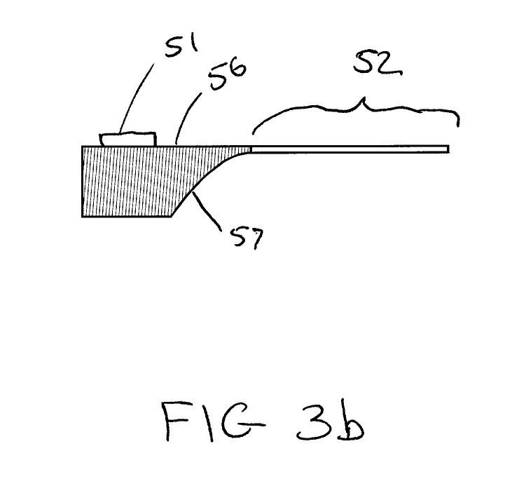

Referring to FIG. 3, a thin film SAW modulator 50 is shown The active area 52 consists of a thin membrane 54. The thin membrane 54 is formed by removing most of the underlying piezoelectric substrate material 56 (e.g. by etching). Due to the mismatch in mechanical impedance between the thin membrane 54 and the bulk piezoelectric material 56, the amplitude of the surface acoustic wave 58 produced by IDT 51 is magnified as it passes through the thin membrane 54, resulting in greater diffraction efficiency. In this example, the surface acoustic waves can be flexural waves. In one embodiment the thin membrane may be made by etching away part of the piezoelectric substrate. In another embodiment, the thin membrane may be attached to the substrate, and is not itself piezoelectric. In yet another embodiment, neither the thin membrane nor the substrate is piezoelectric. In addition, a thin membrane can be constructed on a substrate and then an actuation layer may be deposited on the membrane. A reflective surface may be deposited on top of the actuation layer.

The thin membrane may be coated with a reflective material. The SAW SLM may be made up of a plurality of thin membrane modulators. In one embodiment, the location of the SAW actuators (e.g. IDTs) are located on the thin membrane. In another embodiment, as shown in FIG. 3b, the IDT 51 is located off the thin membrane. The transition 57 between the thin membrane region and the thicker substrate may be smooth, gradual, or otherwise engineered to reduce possible reflections due to a mismatch in mechanical impedance.

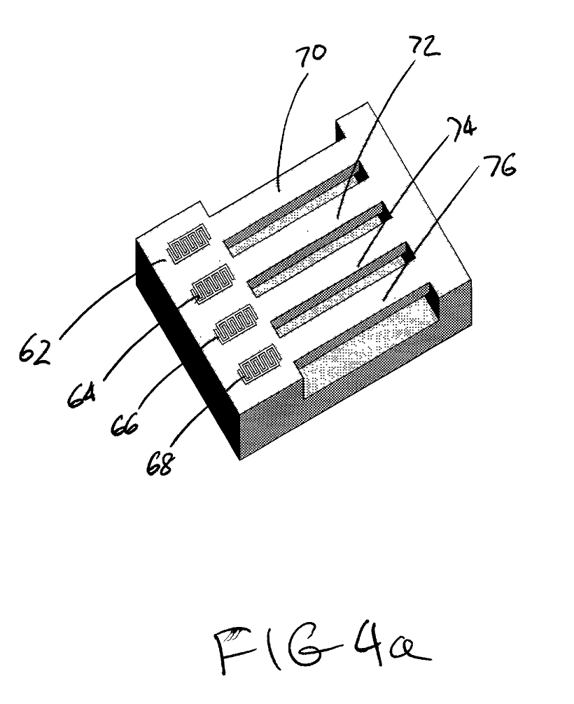

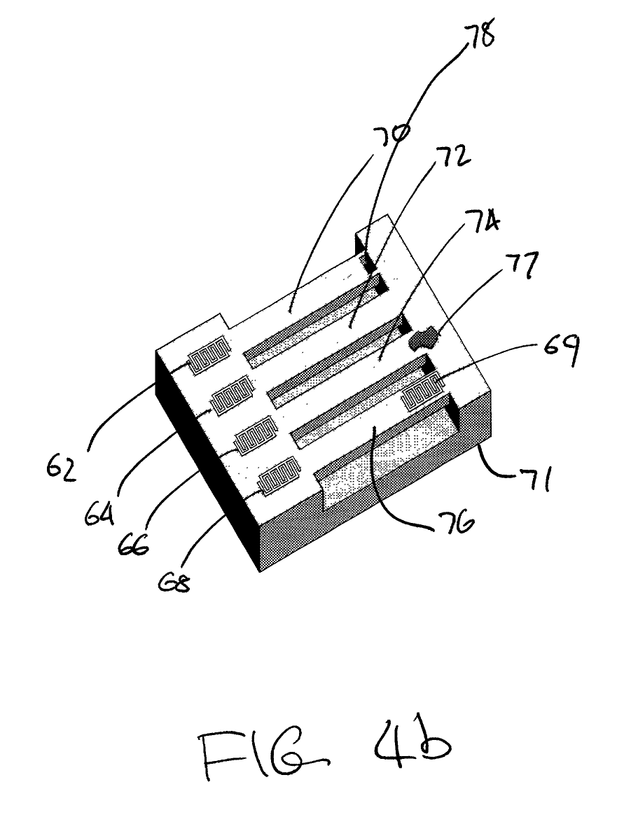

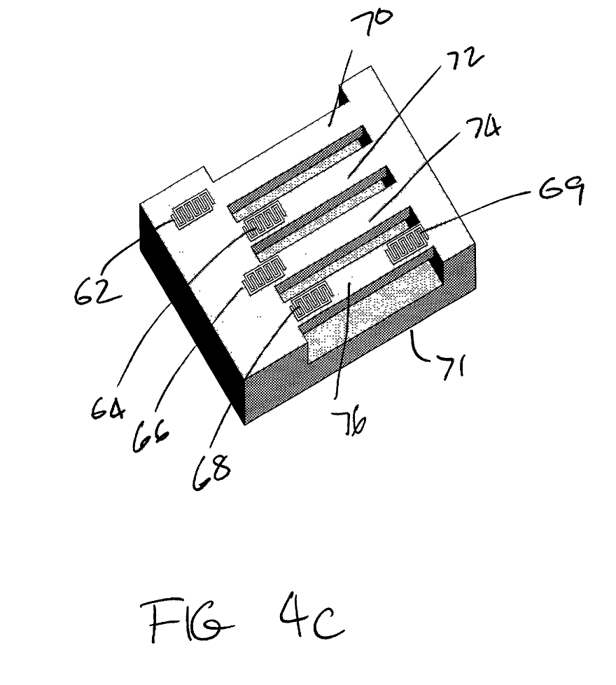

FIG. 4a shows an embodiment of a thin film SAW modulator in which IDTs 62, 64, 66 and 68 are located at one end of thin membranes 70, 72, 74 and 76. Other configurations have other beneficial aspects. For example, FIG. 4b shows an embodiment of a thin film SAW modulator in which a plurality of IDTs 62, 64, 66 and 68 are at one end of a plurality of thin membranes 70, 72, 74 and 76 and another IDT 69 at the opposite end (from IDT 68) of the thin membrane 76 shown on the membrane, providing regeneration of electrical energy from the mechanical energy. IDT 69 may also be off the membrane with similar effect. The end of thin membrane 74 opposite IDT 66 is adjacent to acoustic absorbing material 77 so that mechanical reflections are minimized. At the end opposite IDT 62 of thin membrane 70 is a cavity to minimally constrain the end of membrane 70, resulting in higher efficiency reflections of SAWs than as shown in thin membrane 72 being fully constrained by the substrate 71.Other geometries provide reduced mechanical reflections. FIG. 4c shows IDTs 64 and 69 fully located on thin membranes 72 and 76, respectively. IDT 66 is shown partially on and partially off thin membrane 74.

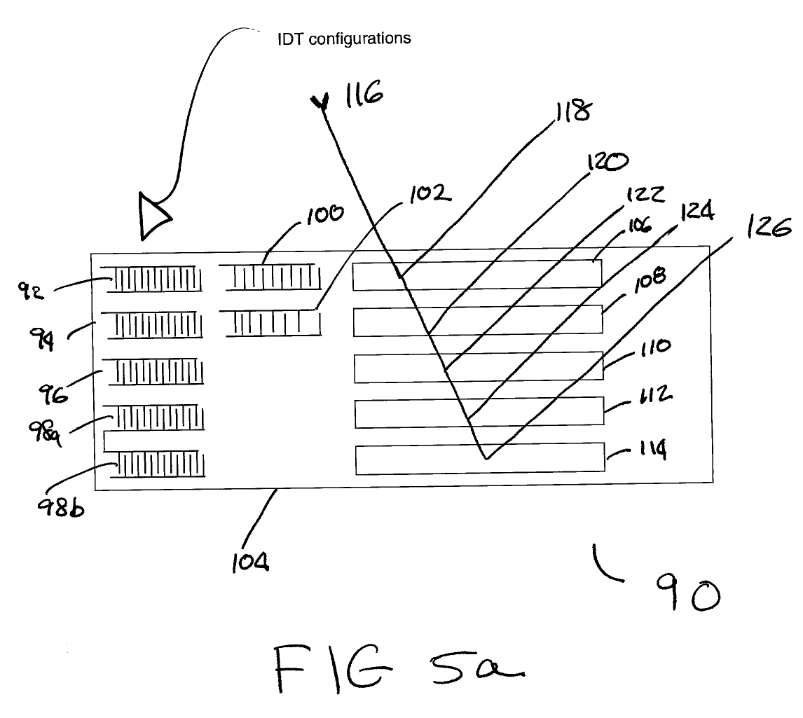

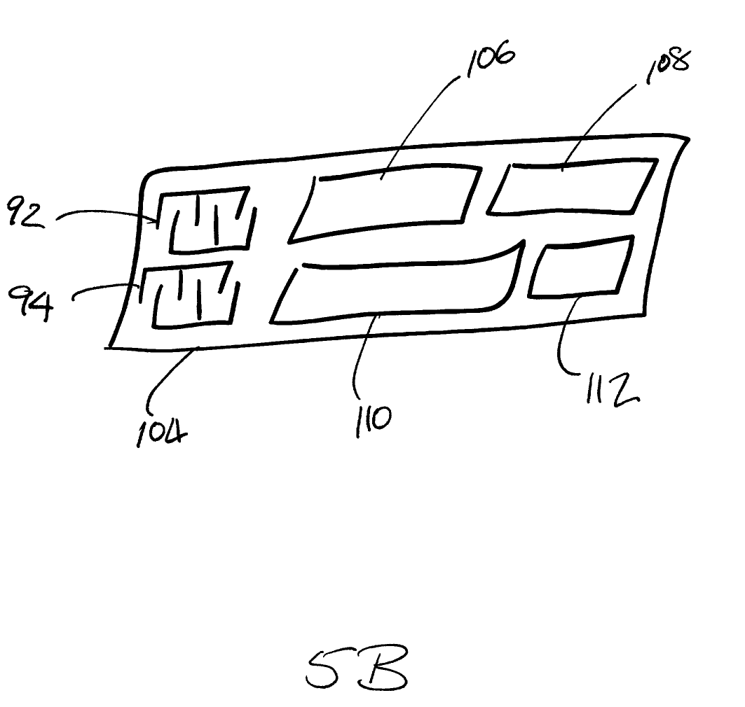

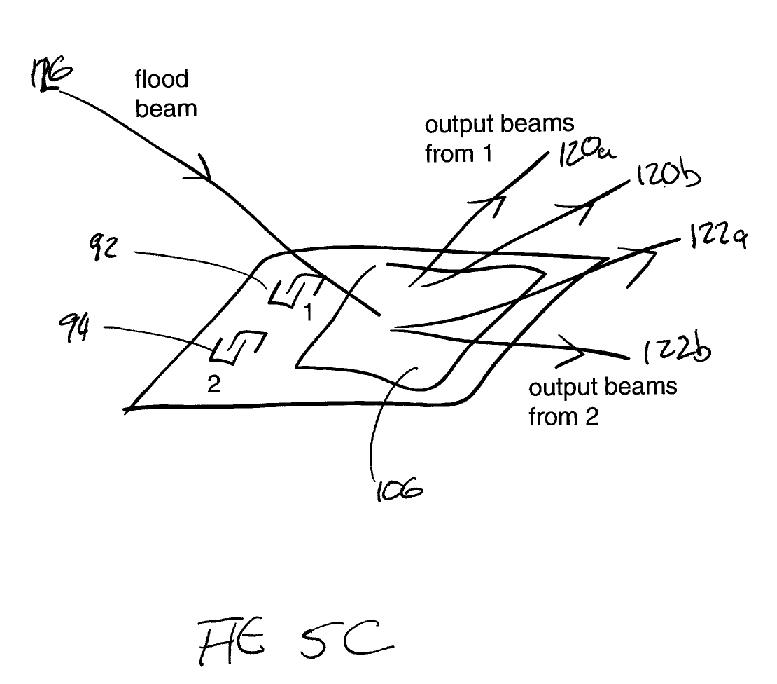

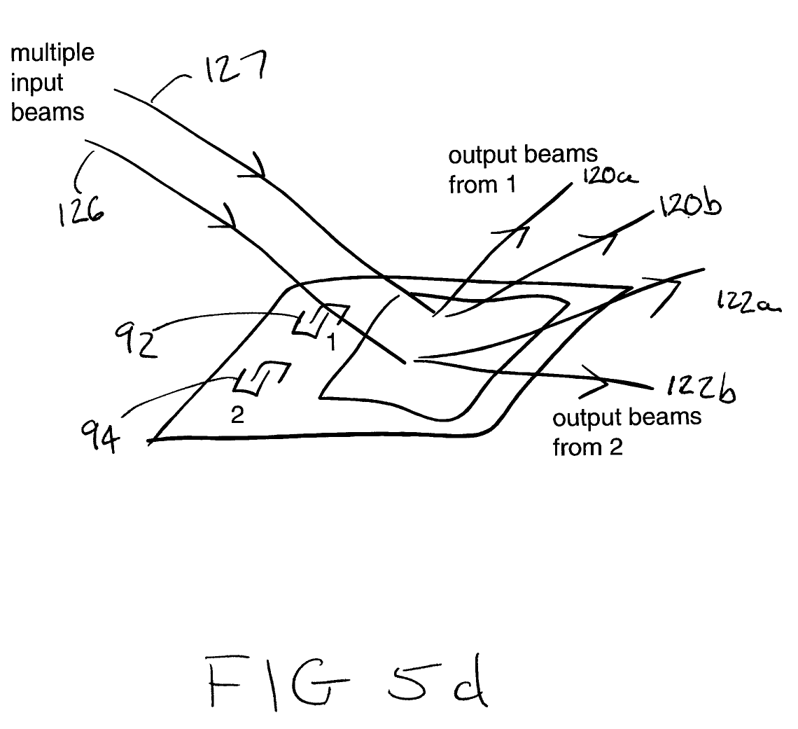

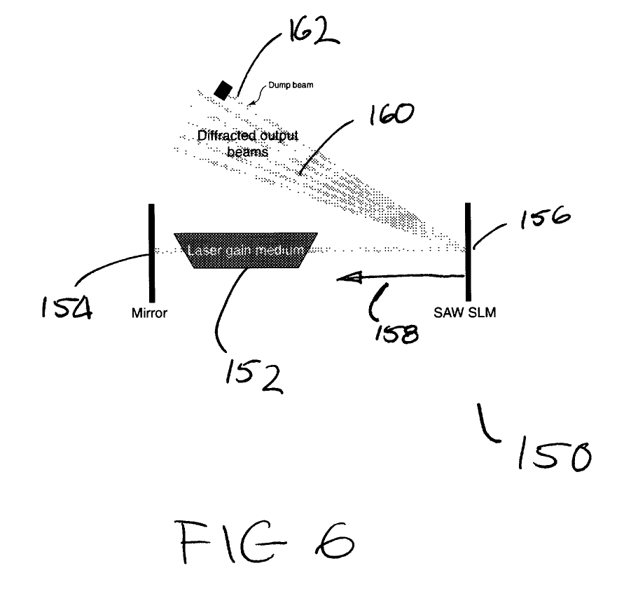

With reference to FIG. 5a, incident radiation 116 impinges on multiple active regions 106, 108, 110, 112 and 114. Each active area 106, 108, 110, 112 and 114 provides independent control of direction, amplitude, phase and frequency of the associated respective output beams 118, 120, 122, 124 and 126. In addition, each modulator in an array can modulate a separate incident beam. In this example, the SAW modulators 92, 94, 96, 98a, 98b, 100 and 102 are deposited on the same piezoelectric substrate 104. Each modulator 92, 94, 96, 98a, 98b, 100 and 102 is driven with a corresponding signal with potentially unique frequency, phase, and/or amplitude. An incident beam of radiation 116 is diffracted independently by each SAW active area 106, 108, 110, 112 and 114. Taking the 1^{st} diffraction orders for simplicity, diffracted beams 118, 120, 122, 124 and 126 correspond to drive frequencies f₁-f₅ (not shown). The active areas 106, 108, 110, 112 and 114 and/or IDT 92, 94, 96, 98a, 98b, 100 and 102 regions may be separated by air gaps, sidewalls, acoustic absorbing material, or otherwise isolated, to reduce crosstalk between the SAW modulators. These methods provide a spatial derivative in the mechanical impedance for traveling waves. Several IDTs with different finger pitch (e.g. IDTs 92 and 100, and 94 and 102) can be deposited serially in a single SAW modulator to increase the SAW amplitude or to broaden the frequency response of the modulator. Furthermore, a given IDT may have an irregular finger spacing (e.g. a chirped pitch) in order to broaden the frequency response. Multiple SAW modulators can share the same ground plane, resulting in reduced wiring demand and increased noise immunity.

Referring to FIG. 5b, a common IDT 92 may be used to control multiple active areas 106 and 108, as well as a second arrangement with common IDT 94 controlling multiple active areas 110 and 112. This can be useful when different types of active areas need to be modulated with the same signal. For example, each active area 106 and 108 could possess a different mechanical response to the same SAW generated by the single IDT.

FIG. 5c shows a configuration wherein multiple IDTs 92 and 94 control a single, common active area 106, resulting in input flood beam 126 being reflected into output beams 120a and 120b controlled by IDT 92, and output beams 122a and 122b controlled by IDT 94. In FIG. 5D, instead of a flood beam, multiple input beams 126 and 127 directed at active area 106 result in output beams 120a and 120b controlled by IDT 92, and output beams 122a and 122b controlled by IDT 94.

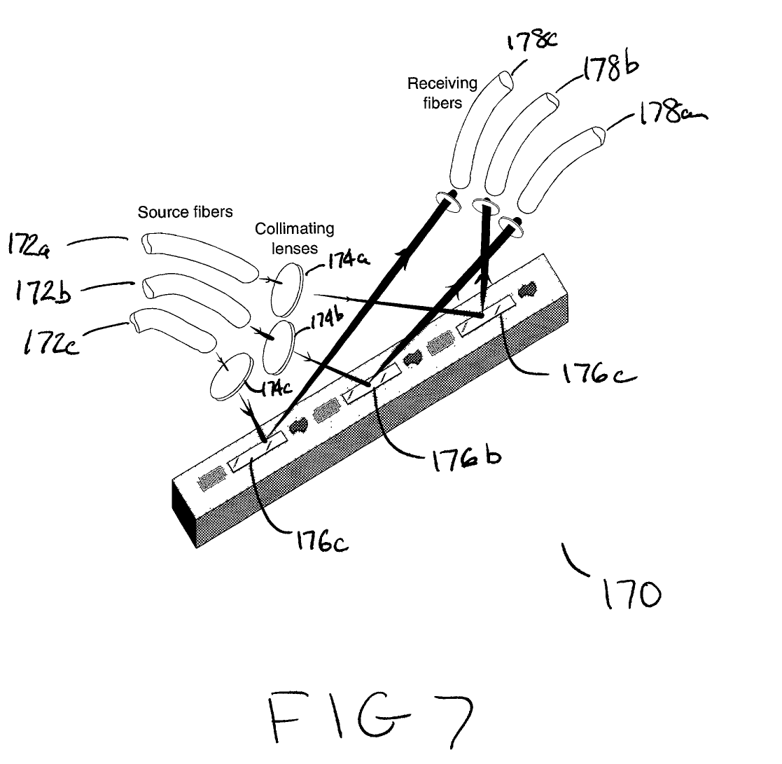

Referring to FIG. 6, a laser cavity with an active SAW SLM output coupler 150 is shown. The laser cavity has an active region 152, a high reflectivity mirror 154 at one end, and a reflective SAW spatial light modulator 156 at the other end. In one embodiment the 0^{th} order beams 158 reflected from the SAW modulators 156 are directed back into the cavity for further amplification, while the 1^{st} order beams 160 are coupled out of the cavity. In this example total internal reflection inside a prism (not shown) is used to separate output beams from the other diffracted beams, and a cylindrical lens (not shown) is used to expand the laser beam to fill the SLM. Furthermore, one of the output beams 162 from the active output coupler is shown used to divert an amount of power from the feedback beam that compensates for the varying draw of the other output beams.

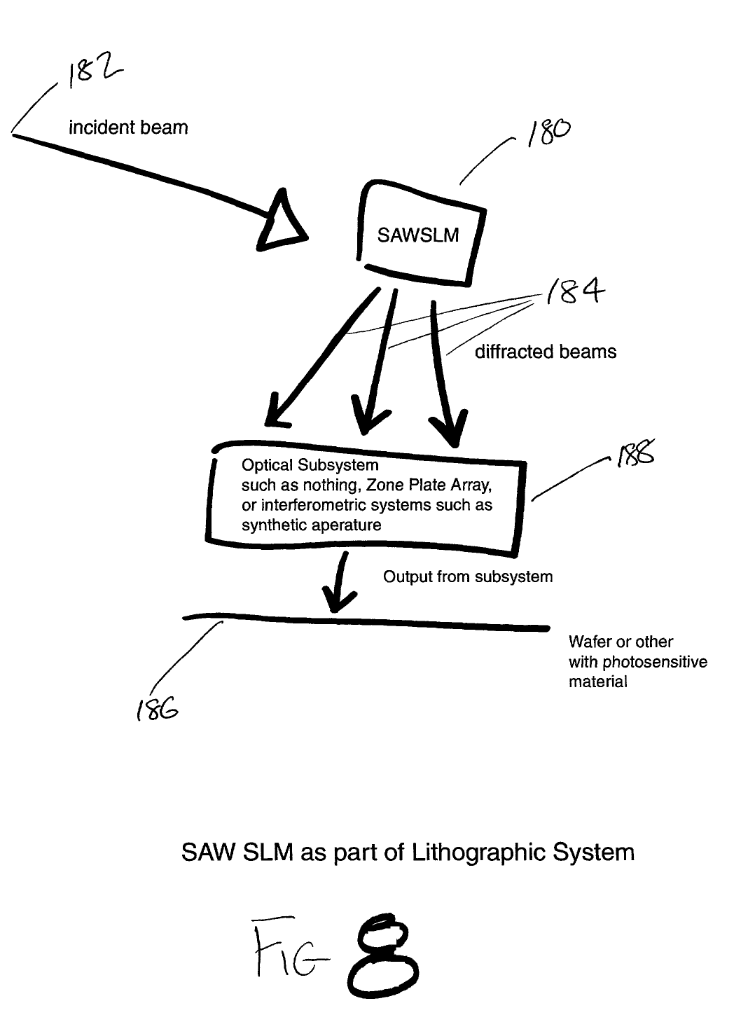

Referring to FIG. 7, a fiber-optic switch 170 is shown. Light beams are collected from an array of input optical fibers 172a , 172b and 172c through collimating lenses 174a, 174b and 174c and directed towards a corresponding array of SAW modulators 176a, 176b and 176c. Upon diffraction by the corresponding SAW modulator, each light beam is directed towards and collected by one of the corresponding output fibers 178a, 178b and 178c. Thus, control signals driving each SAW modulator array 176a, 176b and 176c determine the optical links between input and output fibers. One result of the grating equation is that diffraction by a grating is directionally symmetric. As a result, the information flow through the switch can be bidirectional.

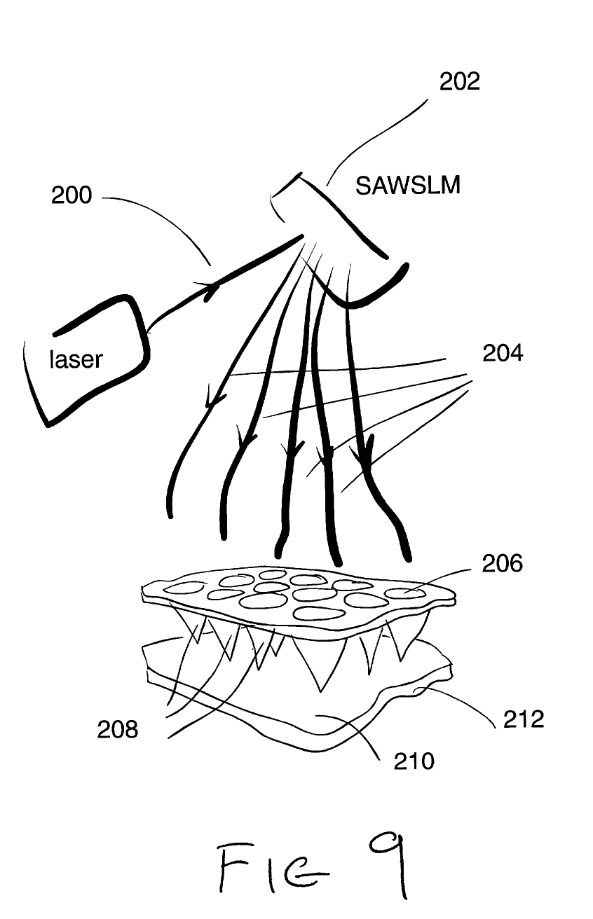

Referring to FIG. 8, a SAW SLM 180 is shown as a part of a lithographic system (e.g. semiconductor manufacturing). An incident beam of radiation 182 is directed at the SAW SLM and diffracted beams 184 are either directed directly to a prepared semiconductor wafer 186, or may be directed through an optical subsystem 188. The wafer may be coated with a photosensitive material, such as photoresist, or may be uncoated. The optical subsystem 188 may include one or more of a zone plate array, interferometric systems, such as a synthetic aperture, and optical switches.

Essentially the reverse of the lithographic system, FIG. 8a shows a microscopy application using a SAW SLM. Radiation source 190 directs radiation 191 to SAW SLM 192, which controls the radiation 196 sent through optical subsystem 193 and then directed 197 to a target 194. The radiation is reflected 198 through optical subsystem 193 (although the path through the optical subsystem 193 need not be the same) to detector 195.

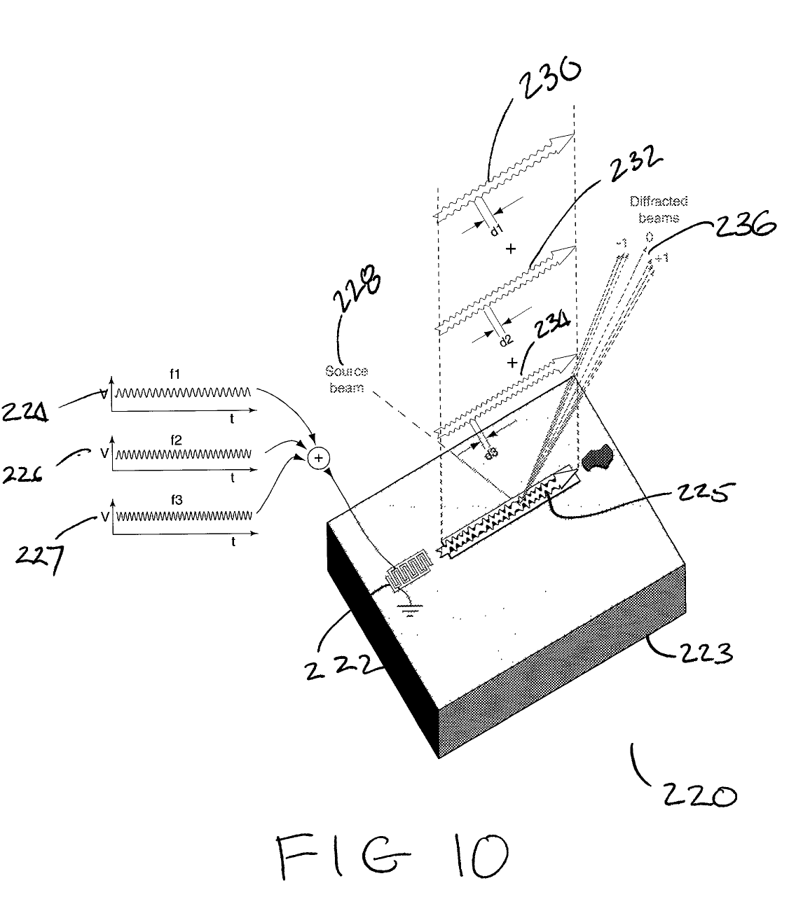

Referring to FIG. 9, an example of a maskless lithography system using a SAW modulator is shown. A laser beam 200 is directed at a SAW modulator 202, which reflects diffracted beams 204 through one or more zone plates 206 creating one or more focused beamlets 208 directed onto a photosensitive material 210 deposited on a substrate 212.

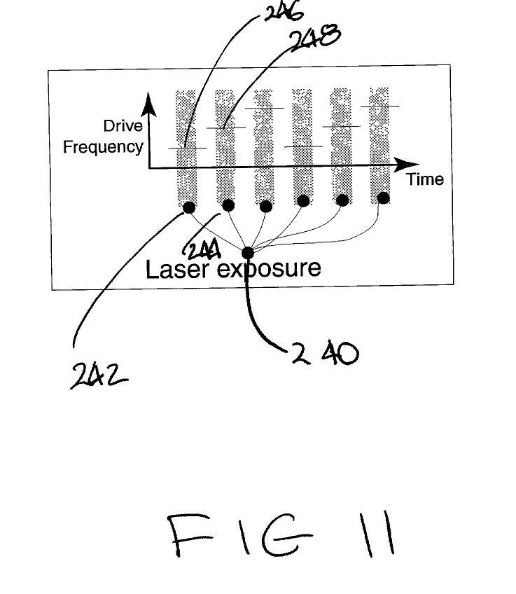

Referring to FIG. 10, a multifrequency SAW modulator 220 is shown. A single IDT 222 is located on a substrate 223, and may be used to drive an active reflective region 225. If the IDT 222 is driven by a multifrequency stimulus, a superposition of SAW gratings in the active area results. A superposition of a plurality of frequencies 224, 226 and 228 (three are shown but the number of frequencies may be fewer or greater) a superposition of SAWs 230, 232 and 234 derived from driving frequencies 224, 226 and 228 are directed into the active region 225. This results in a multiplicity of diffracted beams 236 corresponding to the superposition of SAWs.

Multiple beams can be controlled using the SAW SLM by multiplexing different control stimuli. There are several implementations of multiplexing that are possible with the SAW SLM. The multiplexing schemes include:

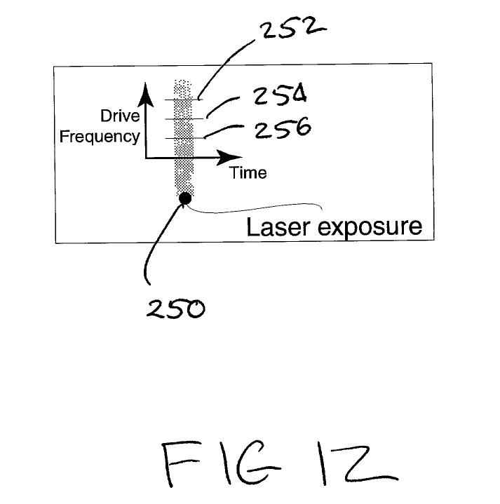

Time multiplexing. The control signals are sequenced over time, producing different beams at different times. FIG. 11 shows a graph of time multiplexing. A laser beam 240 is turned on at varying times 242 and 244, and different control signals 246 and 248 are presented to the SAW SLM at the corresponding times 242 and 244.

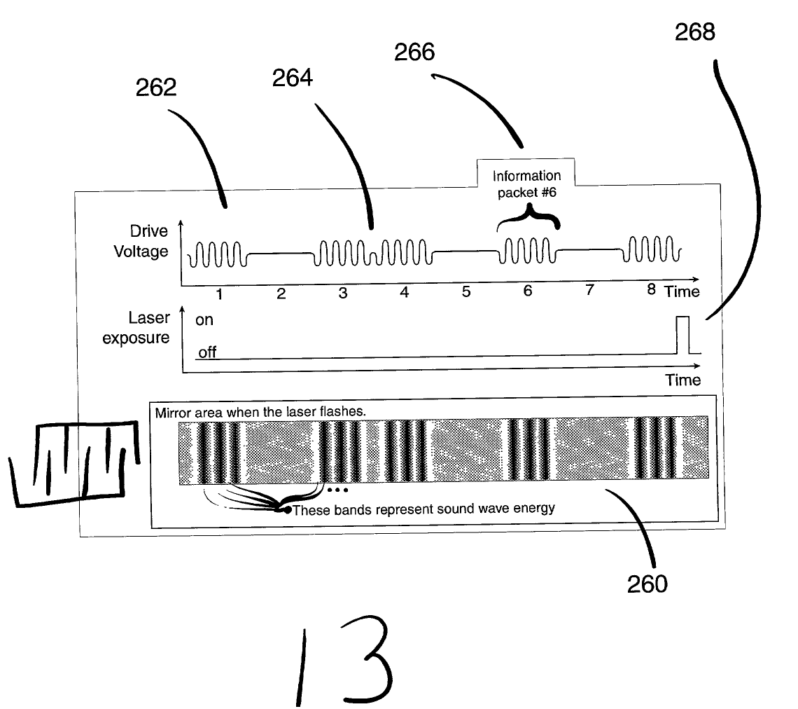

Frequency multiplexing. Referring to FIG. 12, a graph of frequency multiplexing is shown. A laser beam 250 is directed to a SAWSLM (not shown) driven by control signal composed of a combination (superposition) of frequencies 252, 254 and 256. The combined signal produces a composite diffraction pattern in the active area. The diffraction pattern produces a number of beams with different direction and phase depending on the frequency content of the original control stimulus.

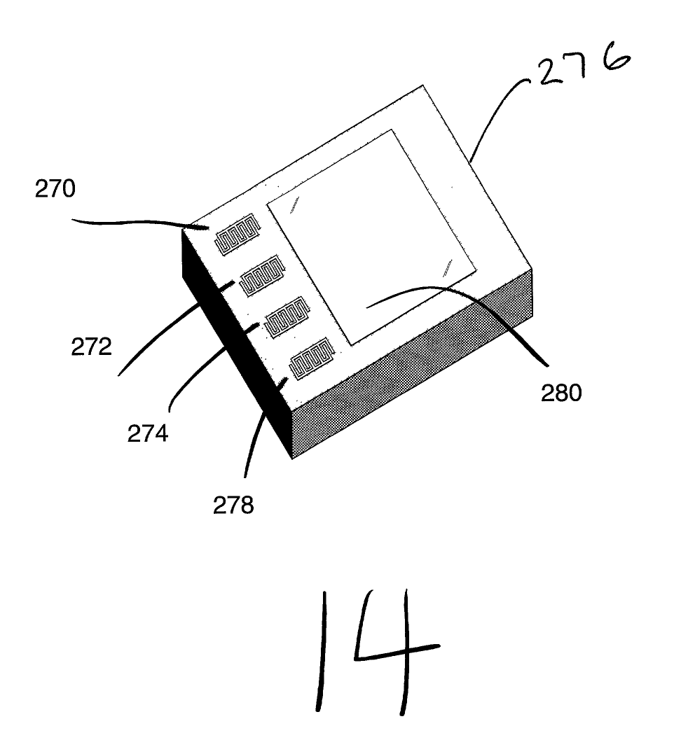

Packet multiplexing. FIG. 13 shows a graph of packet multiplexing. Different control signals 262, 264 and 266 are sent to the SAW SLM in a temporal sequence. Each control signal 262, 264 and 266 potentially provides a different direction and phase to the reflected beam. Thus, the active area 260 provides a spatial sequence of diffracting surfaces as the acoustic waves propagate across the active area 260. When the desired sequence is obtained within the area, the laser 268 (or other light source) is flashed producing multiple controlled beams.

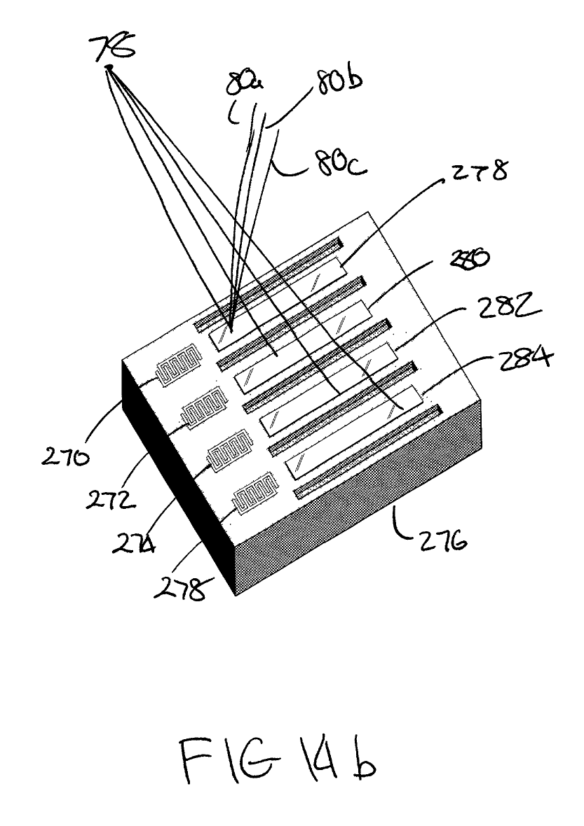

Channel multiplexing. Referring to FIG. 14, an embodiment is shown with a single active area 280 controlled by multiple IDTs 270, 272, 274 and 278. Interdigital surface acoustic wave transducers 270, 272, 274 and 278 are deposited on a piezoelectric substrate 276. Each IDT generates SAWs in a common, single adjacent active area 280. Each IDT 270, 272, 274 and 278 has regularly spaced fingers having width and pitch optimized for operating the SAW modulator with a single frequency drive stimulus. The fingers may be irregularly spaced to broaden the frequency response of the SAW modulator. Acoustic waves from IDTs of different finger pitch may also be combined to broaden the frequency response of the modulator. In some applications, the source radiation has a low duty cycle and pulse rate, such as in excimer lasers in the deep ultraviolet. In such applications, the active area serves as a shift register, receiving and storing information serially, and presenting it to an optical carrier in parallel. Accordingly, the sustainable information throughput is unaffected by the sparsely timed illumination, resulting in speed benefits in such applications as maskless lithography or pulsed illumination applications. FIG. 14a shows a channel multiplexing configuration using multiple active areas 278, 280, 282 and 284 each controlled by IDTs 270, 272, 274 and 278 respectively.

Combination multiplexing. A number of control signals, for example from multiple IDTs, can implement a combination of Time, Frequency, and Packet multiplexing schemes.

Other embodiments may include an active area that is patterned, has a nonrectangular shape, lies on a curved surface, or is comprised of sections of different materials.

In one embodiment some of the drive and control circuitry is manufactured on the same substrate. In another embodiment each SAW modulator is located on a separate substrate. This may be the case if the SLM conforms to a nonplanar surface.

In an exemplary embodiment, the substrate was a three inch wafer of YZ lithium niobate. Because lithium niobate is an anisotropic crystal the transducers are aligned with the Y axis so that the surface acoustic waves travel down the Y axis which has constant material properties.

There were twelve active areas each addressed by two transducers. A mirror was patterned over the active areas to improve the diffraction efficiency. The transducers ranged in length from 1 mm to 10 mm and in width from 0.5 mm to 2 mm. The spacing between interconnected transducer fingers ranged from 43 micrometers to 348 micrometers. The width of the fingers was ¼ of their pitch for optimum power transfer between the drive signal and the substrate.

An arbitrary frequency generator was used to create a 20 MHz 0.1V peak to peak sine wave that is amplified 40 dB by a two Watt RF amplifier. The signal output of the RF amplifier was connected to one terminal of two or more transducers. The other terminals of the transducers to be driven were connected to ground.

A helium-neon laser beam directed along an axis normal to the substrate was used to illuminate the active areas.

A number of embodiments of the invention have been described. Nevertheless, it will be understood that various modifications may be made without departing from the spirit and scope of the invention. For example, the surface acoustic wave could be in the form of a flexural wave in a thin membrane. By using a membrane, the amplitude of the propagating wave, for a given transducer input, can be increased and thereby increase the efficiency of the reflective grating. In addition, the inter-digital transducers can be shaped to reduce the power density required to produce a given surface acoustic wave. A variety of stimulation sources may be used, including but not limited to electrical, mechanical, thermal and optical. Actuation materials need not be limited to piezoelectric materials, but may include but are not limited to ferromagnetic, pyroelectric, electrostatic, thermal absorptive and photoelectric materials. Sources of SAWs need not be limited to IDTs. Surface acoustic waves may be produced by other mechanisms such as a surface wedge transducer, a focused bulk wave transducer, a comb transducer, a pulsed laser transducer, and a meander line transducer.

It is evident that those skilled in the art may make numerous variations of and departures from the specific apparatus and techniques described herein without departing from the inventive concepts. Accordingly, other embodiments are within the scope of the following claims. Consequently, the invention is to be construed as embracing each and every novel feature and novel combination of features disclosed herein and limited solely by the spirit and scope of the appended claims.

What is claimed is:

1. A method for spatially modulating radiation comprising:
directing at least one radiation beam upon at least one surface acoustic wave diffractive element;
and driving at least one of said surface acoustic diffractive elements with a plurality of modulating signals to generate a plurality of independently modulated output radiation beams having parameters.

2. The method of claim 1 wherein the modulating signals are electrical.

3. The method of claim 1 wherein the driving comprises modulating at least one output radiation beam parameter selected from the group consisting of the direction, the amplitude, phase, and frequency of the modulated output radiation beams.

4. The method of claim 2 wherein the driving comprises applying a plurality of separate modulating signals for each surface acoustic wave diffractive element.

5. The method of claim 4 wherein at least one of the modulating signals is characterized by a plurality of frequencies.

6. The method of claim 1 wherein the radiation beam directing is with a laser.

7. The method of claim 1 wherein the radiation beam directing is with a pulsed radiation beam.

8. The method of claim 7 including timing the pulse of radiation to diffract from a surface acoustic wave diffractive element after a predetermined diffractive pattern has propagated to a predetermined location.

9. The method of claim 1 and further comprising directing the modulated output radiation beams upon photosensitive material.

10. Apparatus for spatially modulating radiation comprising:

10. Apparatus for spatially modulating radiation comprising:
at least one surface acoustic wave diffractive element, each element having a surface,
at least one transducer of surface acoustic waves,
a source of a plurality of modulating signals driving the at least one transducer to transduce a surface acoustic wave in the surface of at least one of said surface acoustic wave diffractive elements,
a source of at least one input radiation beam constructed and arranged so that at least a portion of the input radiation beam strikes a surface acoustic wave diffractive element from outside the surface of that surface acoustic wave diffractive element,
and a plurality of modulated output radiation beams modulated by respective ones of said modulating signals.

11. The apparatus of claim 10 wherein the source of radiation is a laser having a cavity.

12. The apparatus of claim 11 wherein the surface acoustic wave diffractive elements are positioned inside the laser cavity so as to direct the output radiation beams out of the laser cavity.

13. The apparatus of claim 12 further comprising an optical beam director system in optical communication with the at least one surface acoustic wave diffraction element, which optical beam director system is constructed and arranged to direct the input radiation beam into the laser cavity and the modulated radiation beams out of the laser cavity.

14. The apparatus of claim 10 wherein said at least one surface acoustic wave diffractive element has an active area.

15. The apparatus of claim 14 wherein the active area is a piezoelectric.

16. The apparatus of claim 14 wherein said active area has a reflectivity greater than zero.

17. The apparatus of claim 14 wherein said active area has a transmissivity greater than zero.

18. The apparatus of claim 14 wherein the active area is patterned.

19. The apparatus of claim 14 wherein said active area is on a curved surface.

20. The apparatus of claim 14 wherein said active area comprises multiple regions with different material.

21. The apparatus of claim 14 wherein the transducer comprises interdigital electrodes deposited on top of a piezoelectric substrate.

22. The apparatus of claim 21 wherein the interdigital electrodes are regularly spaced.

23. The apparatus of claim 21 wherein the interdigital electrodes are irregularly spaced.

24. The apparatus of claim 10 wherein the at least one surface acoustic wave diffractive element includes at least one transducer to create surface acoustic waves in a plurality of adjacent active areas, the plurality of adjacent active areas being situated so as to receive portions of the source of beam of radiation and wherein the transducer is used to generate surface acoustic waves in the plurality of active areas.

25. The apparatus of claim 24 wherein the at least one transducer responds to at least one frequency of the modulating signals.

26. The apparatus of claim 14 and further comprising a second transducer, the at least one transducer being electrically connected to said second transducer.

27. The apparatus of claim 14 and further comprising at least one second transducer constructed and arranged to transduce acoustic energy into electrical energy.

28. The apparatus of claim 14 and further comprising a second surface acoustic wave diffractive element wherein the at least one surface acoustic wave diffractive element is located on the same substrate as the second surface acoustic wave diffractive element.

29. The apparatus of claim 28 wherein the at least a first surface acoustic wave diffractive element is separated from the at least a second surface acoustic wave diffractive element by gaps in the substrate.

30. The apparatus of claim 10 wherein the source of modulating signals provides radio frequency electrical signals.
